(19) United States
(12) Patent Application Publication
(10) Pub. No.: US 2026/0091843 A1
(43) Pub. Date: Apr. 2, 2026

(54) ENERGY-SAVING BRAKE LEVER ASSEMBLY FOR VEHICLES

(71) Applicant: Bartosh Wojtaszyk, Fountain Hills, AZ (US)

(72) Inventor: Bartosh Wojtaszyk, Fountain Hills, AZ (US)

(21) Appl. No.: 18/900,929

(22) Filed: Sep. 30, 2024

(51) Int. Cl. B62L 3/02

(52) U.S. Cl. CPC B62L 3/02

(57) ABSTRACT

An energy-saving brake lever assembly for a brake device includes a casing having a socket section and a pivot section. The socket section is connected to a vehicle and positioned near a handlebar of the vehicle. A brake lever assembly is pivotally connected to the pivot section. A control device is connected between the brake lever assembly and a brake caliper assembly. A pin is inserted through the pivot section and the brake lever assembly so that the brake lever assembly is pivotable relative to the casing. A torsion spring is located in the pivot section and mounted on the pin. The torsion spring is biased between the pivot section and the brake lever assembly. A torsional force of the spring is less than a clamping force of the brake caliper assembly. The users use a less force to pull the brake lever assembly to complete a brake.

### FIELD OF THE INVENTION

The present invention relates to an energy-saving brake lever assembly for a brake device of vehicles.

### BACKGROUND OF THE INVENTION

Bicycles and motorcycles are among the common short-distance transportation tools today (referred to below as two-wheelers). The heaviest part of these two-wheelers is the brake device that protects the rider's safety. It is mainly used to slow down or stop the speed, thereby ensuring the safety of the cyclist. However, depending on the usage of different two-wheelers, such as in off-road competitions, triathlons, or general riding, the application of the brake device can be controlled. Some two-wheelers require a larger force to control the brakes. For riders with greater strength, applying pressure may not be difficult, but using extreme force for a prolonged period will quickly tire the fingers. This creates a certain disadvantage in competitions as it becomes challenging to accurately control the brakes according to the road conditions. This is especially true in off-road vehicle usage where, due to the terrain, the brake lever often needs to be controlled with a press-and-release method. If the pressure applied is not complete, the rider cannot achieve the optimal riding speed and safety protection.

In general riding, if the rider has less strength, they may not be able to perform emergency braking effectively due to insufficient force. This leads to inadequate braking and the inability to come to a complete stop, posing safety risks to themselves and others.

In addition to the aforementioned control issues with two-wheelers, similar problems exist in switching gears and shifting mechanisms (e.g., in motorcycles). Some gear shifting processes are not smooth due to the substantial force required to operate the brake lever during pressing. This behavior easily increases the mechanical wear rate of two-wheelers and other related issues.

The present invention intends to provide an energy-saving brake lever assembly for a brake device of vehicles to eliminate the shortcomings mentioned above.

### SUMMARY OF THE INVENTION

The present invention relates to an energy-saving brake lever assembly for a brake device and comprises a casing having a socket section and a pivot section. The socket section is connected to a vehicle and positioned near a handlebar of the vehicle. A brake lever assembly is pivotally connected to the pivot section. A control device is connected between the brake lever assembly and a brake caliper assembly. A pin is inserted through the pivot section and the brake lever assembly so that the brake lever assembly is pivotable relative to the casing. A torsion spring is located in the pivot section and mounted on the pin. The torsion spring is biased between the pivot section and the brake lever assembly. A torsional force of the spring is less than a clamping force of the brake caliper assembly. The users uses a less force to pull the brake lever assembly to complete a brake.

The primary object of the present invention is to provide riders with a brake device that can be operated with minimal effort, quickly, and effectively. Compared to conventional braking systems, which often require significant pressure to ensure a complete stop, the present invention aims to reduce the force needed for operation. With prolonged use, traditional systems can quickly lead to finger fatigue and make it difficult to respond effectively during sudden braking situations, potentially resulting in danger to both the rider and others.

The advantages of the present invention are that by the use of the torsion spring, the torsion spring provides the necessary torque to assist the user in pressing the brake lever assembly against the casing. This activates the control device to manage the brake caliper assembly during the braking process. The torque generated by the torsion spring compensates for part of the force needed to operate the brake caliper assembly, allowing the user to apply minimal force to easily press and control the brake lever assembly. This ensures a quick and reliable deceleration and braking operation, thereby protecting the user and others. In contrast to conventional technology, where significant force is required for braking control, prolonged use can lead to finger fatigue. In sudden situations, the user may not be able to apply the necessary force quickly enough, potentially causing danger to themselves and others.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded perspective view of the present invention;

FIG. 3 is a perspective view of the present invention assembled with the brake cable and brake caliper assembly;

FIG. 4 is a cross-sectional view, taken along line IV-IV of FIG. 3.

FIG. 5 is a schematic view illustrating the pressing action of the brake lever assembly as shown in FIG. 4;

FIG. 6 is another perspective view of the present invention from a different angle;

FIG. 7 is a perspective view of another embodiment of the present invention;

FIG. 8 is an exploded schematic view of FIG. 7, and

FIG. 9 is a cross-sectional view, taken along line IX-IX of FIG. 7.

### DETAILED DESCRIPTION OF THE PREFERRED EMBODIMENT

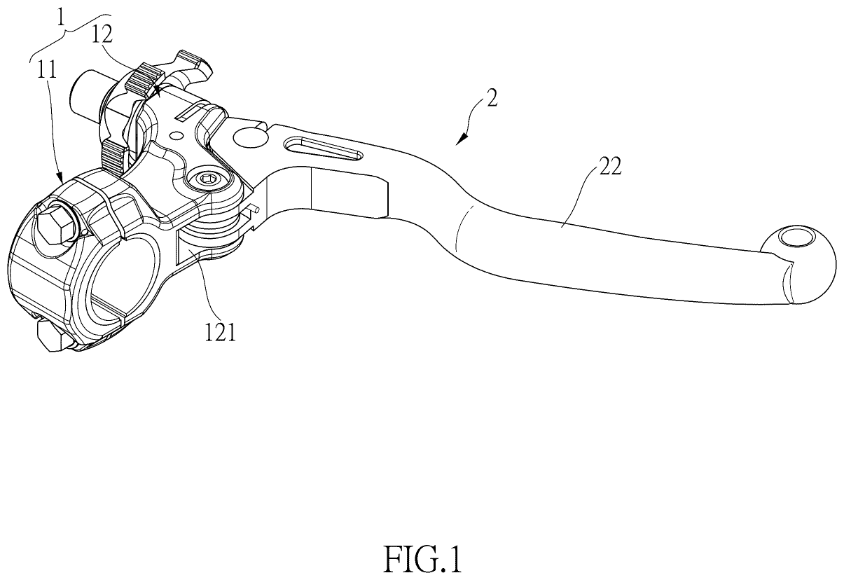

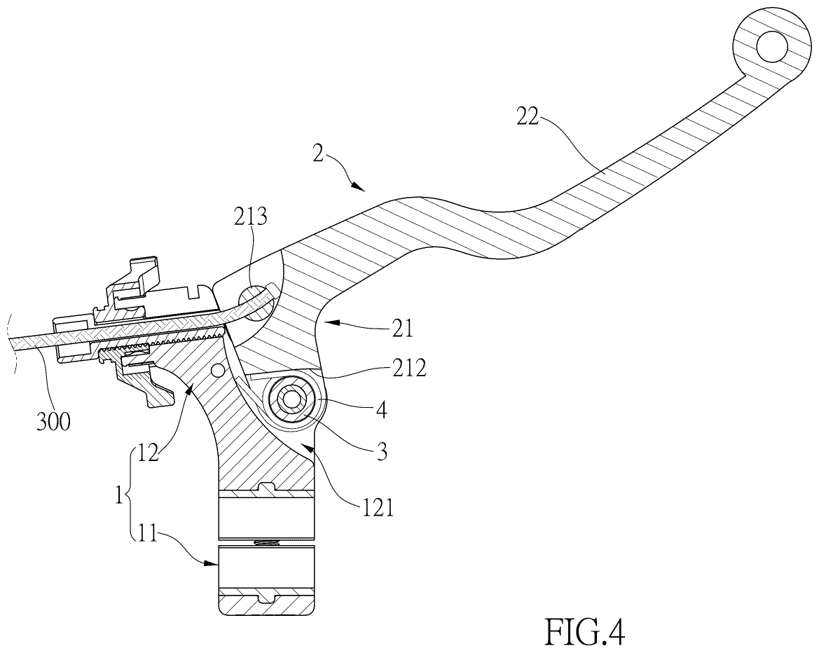

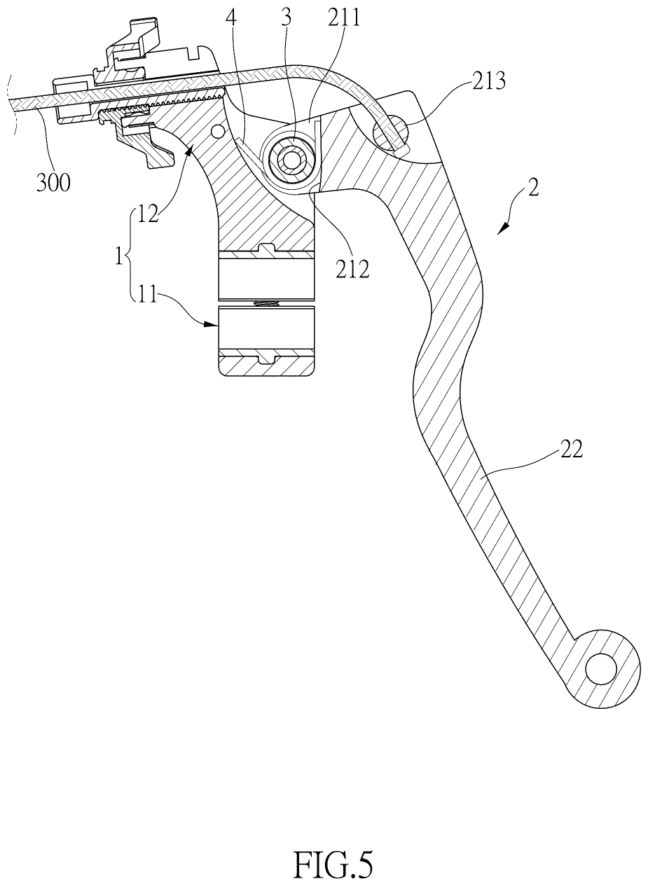

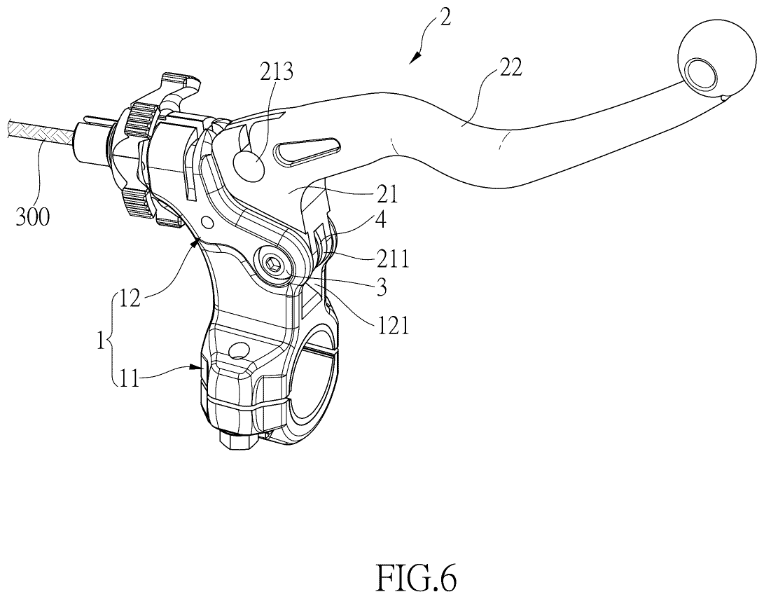

Referring to FIGS. 1 to 6, the present invention is an energy-saving brake lever assembly for a brake device, and is designed for installation on a vehicle (100), near a handlebar (200) (in the illustrated example, installed at one end of the handlebar (200); the illustration shows only one side of the handlebar (200) as a schematic). The energy-saving brake lever is connected to a control device (300), which can be any of a brake cable, a hydraulic brake cable, or a gear shift cable. The energy-saving brake lever comprises a casing (1) having a socket section (11) and a pivot section (12) respectively formed to two ends thereof. The socket section (11) is connected to the vehicle (100) and positioned near the handlebar (200) of the vehicle (100). A brake lever assembly (2) is partially and pivotally connected to the pivot section (12). A first end of the control device (300) passes through the pivot section (12) of the casing (1) and is connected to the brake lever assembly (2). A second end of the control device (300) is connected to the brake caliper assembly (400). A pin (3) is inserted through the pivot section (12) and the brake lever assembly (2) so that the brake lever assembly (2) is pivotable relative to the casing (1). A torsion spring (4) is located in the pivot section (12) and mounted on the pin (3). A first end of the torsion spring (4) presses against the pivot section (12), and a second end of the torsion spring (4) presses against the brake lever assembly (2). The torsional force of the spring (4) is less than the clamping force of the brake caliper assembly (400). Using the force generated by the torsion spring (4) on the brake lever assembly (2), the brake lever assembly (2) can be easily, quickly, and accurately pressed and pivoted against the casing (1). This requires applying a pulling force less than the force of the brake caliper assembly (400) on the control device (300), along with the additional force provided by the torsion spring (4), enabling complete deceleration and braking.

According to the description above, standard brake devices often require a substantial force to control and operate the braking mechanism when slowing down or stopping the vehicle. This is not suitable for users with less strength, and in sudden situations, they might not be able to fully brake in time, leading to potential hazards. The present invention, by incorporating the torsion spring (4), provides a certain degree of elasticity between the brake lever assembly (2) and the casing (1). Therefore, when a user presses the brake lever assembly (2) for clamping and braking, they can easily pivot and press the brake lever assembly (2) relative to the casing (1). The torsion spring (4) already provides elastic resistance between the brake lever assembly (2) and the casing (1), allowing the user to easily and completely press for clamping operations without exerting excessive force, ensuring the safety of themselves and others. There is no need to worry about incomplete control during unexpected situations, significantly improving upon the shortcomings and issues of conventional technologies.

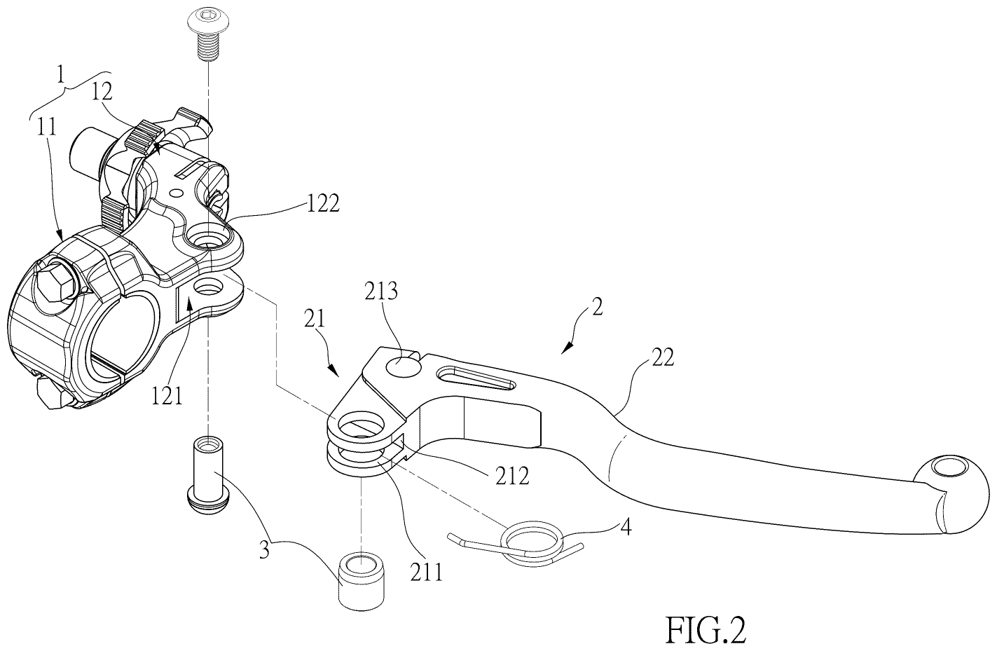

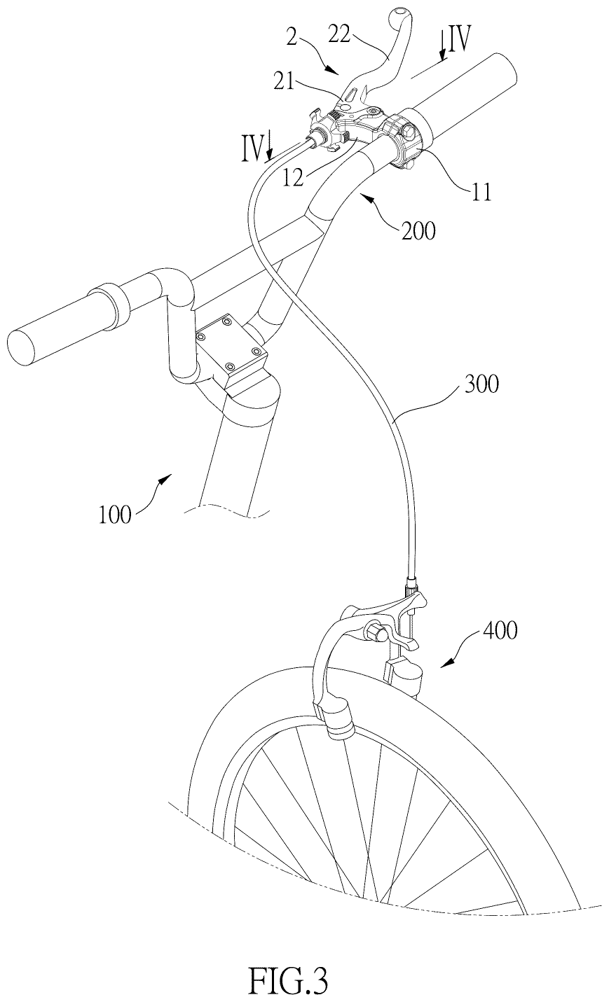

Please refer to FIGS. 2 and 3, for the casing (1), to facilitate the assembly with the brake lever assembly (2), the casing (1) is further recessed at the pivot section (12) to form a recess (121) and a through-hole (122). The through-hole (122) extends from one end of the recess (121), and one end of the control device (300) passes through this through-hole (122) and is connected to the brake lever assembly (2). A part of the brake lever assembly (2) is inserted into the recess (121). The pin (3) extends from the outside of the casing (1), passes through the recess (121) and a part of the brake lever assembly (2) inside the recess (121). The torsion spring (4) is mounted on the pin (3), with one end pressing against the inner wall of the recess (121).

Additionally, the brake lever assembly (2) includes a connection portion (21) and a brake lever (22). The portion of the connection portion (21) inserted into the recess (121) is designed with a groove (211), forming a contact section (212) within the groove (211). The groove (211) communicates with the recess (121), and the torsion spring (4) is mounted onto the pin (3) and positioned within the groove (211), with one end pressing against the contact section (212). The connection portion (21) also features an installation hole (213) on one side, and one end of the control device (300) passes through the pivot section (12) and snaps into the installation hole (213). Thus, by using the torsion spring (4), with its ends respectively pressing against the inner wall of the recess (121) and the contact section (212), the torsion spring (4) can provide a slight elastic force to the connection portion (21) relative to the casing (1).

Based on the description above, for example, during normal brake device pressing control (without the torsion spring (4) of the present invention), a pressing force of, say, 5 Newtons might be required. This means that the user must exert the full corresponding force of 5 Newtons to control the brake caliper assembly (400) effectively. However, some users may find it impossible to exert such force, or they may not be able to instantly apply 5 Newtons in a sudden emergency brake. Therefore, the present invention addresses the above issues by incorporating the torsion spring (4) and using the ends of the torsion spring (4) to press against inner wall of the recess (121) of the casing (1) and the contact section (212) within the groove (211) of the connection portion (21). This setup allows the connection portion (21) to have an initial resistance against the casing (1), so the user needs to apply less than 5 Newtons of force when pressing the brake lever (22). With the added elastic torsion of the torsion spring (4), the combined force enables the user to press the brake lever (22) with ease. This design not only benefits users with less strength but also ensures effective pressing in sudden situations, achieving the deceleration and stopping of the vehicle (100).

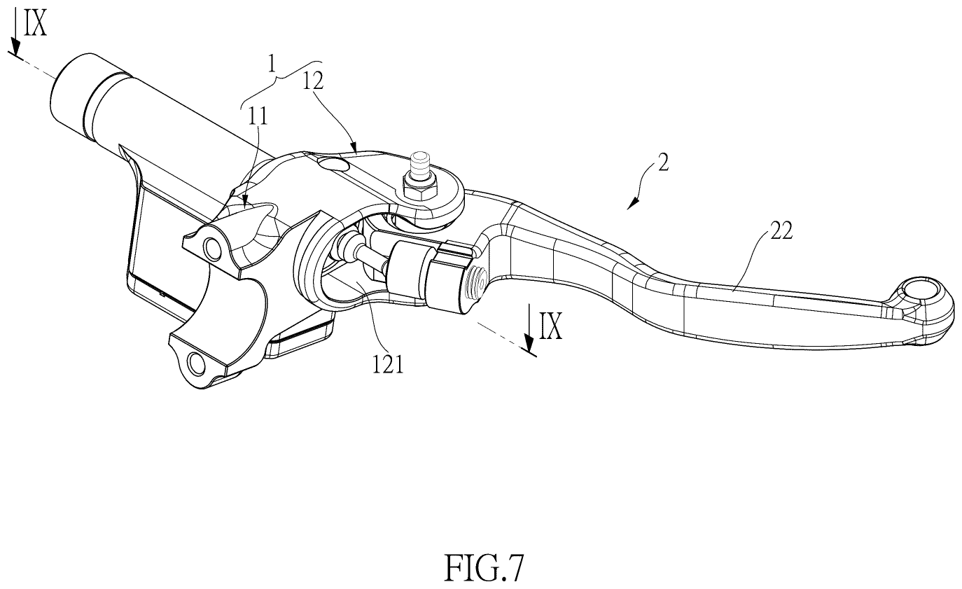

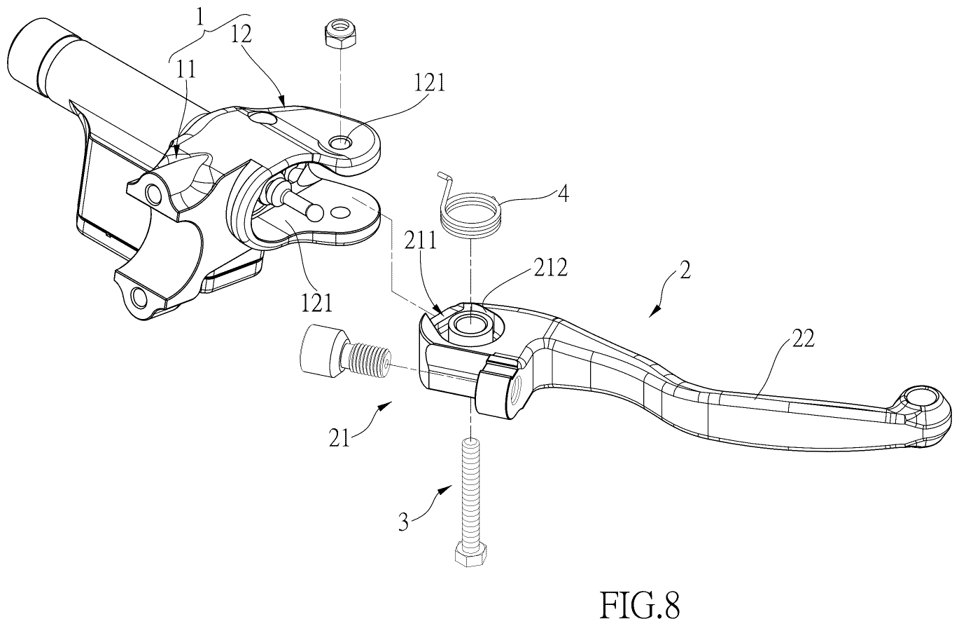

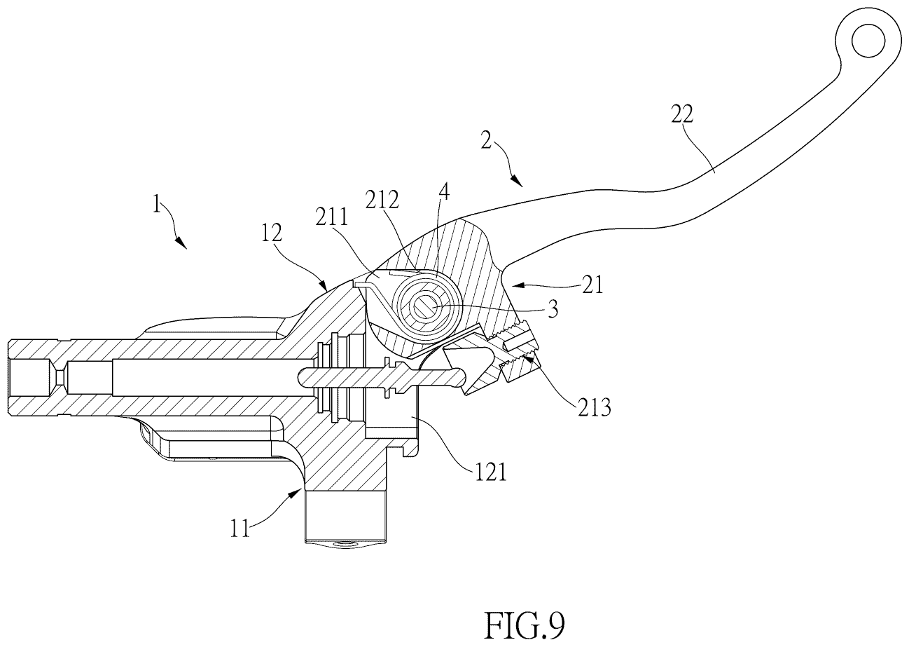

Additionally, it is worth mentioning that the application of the control device (300) in the present invention can be of various types, including a brake cable, a hydraulic brake cable, and a gear-shift cable, among others. Please refer to FIGS. 7 to 9. The structure shown in FIGS. 7 to 9 is largely the same as the previous embodiment, with the only difference being that the controlled structure pertains to a hydraulic system, while the aforementioned embodiment involves cable control. Furthermore, the present invention is compatible with various brake lever types available on the market today, such as brake-related devices that include calipers and C-clamps (which can be either cable-controlled or hydraulic), and gear-shift devices (not shown in the figure). Therefore, the primary objective of the present invention is to provide a more effortless control experience across different brake lever types.

In summary, by incorporating the torsion spring (4), the present invention allows users to apply appropriate force when pressing the brake lever (22). With the added torsion provided by the torsion spring (4), users can effortlessly perform braking operations. This feature is particularly beneficial for users with less physical strength, making brake control easier and more responsive to sudden situations requiring immediate and complete activation of the brake caliper assembly (400) for clamping actions. This ensures the safety of both the user and others. Compared to conventional brake levers, this invention undoubtedly addresses known issues and significantly benefits users with less physical strength in performing braking operations.

While we have shown and described the embodiment in accordance with the present invention, it should be clear to those skilled in the art that further embodiments may be made without departing from the scope of the present invention.

What is claimed is:

1. An energy-saving brake lever assembly for a brake device, comprising:
a casing (1) having a socket section (11) and a pivot section (12) respectively formed to two ends thereof, the socket section (11) adapted to be connected to a vehicle (100) and positioned near a handlebar (200) of the vehicle (100);
a brake lever assembly (2) partially and pivotally connected to the pivot section (12), a first end of a control device (300) passing through the pivot section (12) of the casing (1) and connected to the brake lever assembly (2), a second end of the control device (300) connected to a brake caliper assembly (400);
a pin (3) inserted through the pivot section (12) and the brake lever assembly (2) so that the brake lever assembly (2) is pivotable relative to the casing (1), and
a torsion spring (4) located in the pivot section (12) and mounted on the pin (3), a first end of the torsion spring (4) pressing against the pivot section (12), a second end of the torsion spring (4) pressing against the brake lever assembly (2), a torsional force of the spring (4) being less than a clamping force of the brake caliper assembly (400), wherein by utilizing the torsional force generated by the torsion spring (4) on the brake lever assembly (2), a pulling force less than a force of the brake caliper assembly (400) on the control device (300) is applied to the brake lever assembly (2), the brake lever assembly (2) pivots relative to the casing (1) to brake.

2. The energy-saving brake lever assembly as claimed in claim 1, wherein the casing (1) includes a recess (121) and a through-hole (122) formed in the pivot section (12), the first end of the control device (300) passes through the through-hole (122) and is connected to the brake lever assembly (2), a part of the brake lever assembly (2) is inserted into the recess (121), the pin (3) extends through an outer side of the casing (1) and passes through the recess (121) and a part of the brake lever assembly (2) within the recess (121), the torsion spring (4) is mounted on the pin (3) with the first end of the torsion spring (4) pressing against an inner wall of the recess (121).

3. The energy-saving brake lever assembly as claimed in claim 2, wherein the brake lever assembly (2) includes a connection portion (21) and a brake lever (22), the part of the connection portion (21) inserted into the recess (121) includes a groove (211), a contact section (212) is formed in the groove (211), the groove (211) communicates with the recess (121), the torsion spring (4) is mounted on the pin (3) and positioned within the groove (211), with the first end of the torsion spring (4) pressing against the contact section (212).

4. The energy-saving brake lever assembly as claimed in claim 3, wherein the connection portion (21) includes an installation hole (213), the first end of the control device (300) passes through the pivot section (12) and snaps into the installation hole (213).

5. The energy-saving brake lever assembly as claimed in claim 1, wherein the control device (300) is a brake cable, a hydraulic cable, or a gear-shifting cable.
